(19) United States
(12) Patent Application Publication
(10) Pub. No.: US 2018/0333789 A1
(43) Pub. Date: Nov. 22, 2018

(54) DOUBLE BLADE HOLE-SAW CUP AND PILOT BIT

(71) Applicant: Thomas J. Spera, Raleigh, NC (US)

(72) Inventor: Thomas J. Spera, Raleigh, NC (US)

(21) Appl. No.: 15/986,552

(22) Filed: May 22, 2018

Related U.S. Application Data
(60) Provisional application No. 62/509,334, filed on May 22, 2017.

(51) Int. Cl. B23B 51/04; B23B 31/107

(52) U.S. Cl. CPC B23B 51/0473; B23B 31/1074

(57) ABSTRACT

A hole-saw comprises a cylindrical body, a plate, a mandrel, and a clamping member. A cutting edge is formed at an open end of the body and is disposed about the body's rotational axis. The plate is disposed at an opposite end of the body, is rotationally coupled to the body, and is oriented perpendicular to the body's rotational axis. In one embodiment the cutting edge has at least one inner saw tooth. In another embodiment the cutting edge has at least one outer saw tooth. Other embodiments include a cylindrical body with a cutting edge at both ends. Either cutting edge can have an inner or an outer tooth to easily remove the plug. The pilot drill bit can have a burr to prevent jamming.

### CROSS REFERENCE APPLICATIONS

This application is a non-provisional application claiming priority to provisional application no. 62509334 filed May 22, 2011, which is incorporated herein in its entirety.

### BACKGROUND

Known in the art are plug ejecting hole saw blades. Pub. No. 2002/013/835 discloses a primary, outer, hole saw blade 22B. Then a separate smaller blade is mounted inside the primary blade. After sawing a hole the plug does not jam in the primary blade because the plug has been reduced in diameter by the inner blade. Many variations of these double blade cups exist including U.S. Pat. No. 7,097,397 (2006) to Keightley. The current inventor issued U.S. Pat. No. 9,682,431 on Jun. 20, 2017. These designs save the worker time because he does not have to pry out a plug.

What is needed in the art is a single cup design that helps to prevent the jamming of the plug in the blade. The present invention provides either an inner or an outer secondary saw tooth on the primary blade that reduces the size of the plug. Another invention disclosed herein is a pilot drill bit with a burr to prevent jamming of the drill bit.

### SUMMARY

The main aspect of the present invention is to provide at least one saw tooth on either the inside or the outside of a hole saw blade in order to eliminate a jamming of the plug in the primary hole saw cup.

Another aspect of the present invention is to provide a burr (s) adjacent the tip of a pilot drill bit in a hole saw assembly such that the pilot drill bit does not jam in the workpiece.

These and other features and advantages of the new hole-saw reside in the construction of parts and the combination thereof, the mode of operation and use, as will become more apparent from the following description, reference being made to the accompanying drawings that form a part of this specification wherein like reference characters designate corresponding parts in the several views. The embodiments and features thereof are described and illustrated in conjunction with systems, tools and methods which are meant to exemplify and to illustrate, not being limiting in scope.

### BRIEF DESCRIPTION OF THE DRAWINGS

FIG. 1A (prior art) is a perspective view of a hole saw according to one or more embodiments.

FIG. 1B (prior art) is a perspective view of the hole-saw plate in FIG. 1A.

FIG. 2 (prior art) is a perspective view of a mandrel according to one or more embodiments.

FIG. 3 (prior art) is a perspective view of a threaded collet according to one or more embodiments.

FIG. 4A is a bottom perspective view of a hole saw mounting plate for a blade that has inner saw teeth.

FIG. 4B is a side elevation view of the plate in FIG. 4A.

FIG. 4C is a bottom plan view of the plate in FIG. 4A.

FIG. 4D is a detail view of detail DE shown in FIG. 4C.

FIG. 5A is a perspective view of a hole saw body having inner saw teeth and optional outer saw teeth.

FIG. 5B is a side elevation view of the hole saw body shown in FIG. 5A.

FIG. 5C is a cross sectional view taken along line A-A of FIG. 5B.

FIG. 6A is a top perspective view of a hole-saw body having inner saw teeth.

FIG. 6B is a side elevation view of the hole-saw body of FIG. 6A.

FIG. 6C is a cross sectional view taken along line A-A of FIG. 6B.

FIG. 7A is a top or bottom plan view of an alternate embodiment inner teeth design.

FIG. 7B is a top or bottom plan view of one embodiment of an outer teeth design.

FIG. 8A is a side elevation view of one embodiment of a single sided burr on a pilot drill bit.

FIG. 8B is a side elevation view of one embodiment of a dual sided burr on a pilot drill bit.

Before explaining the disclosed embodiments in detail, it is to be understood that the embodiments are not limited in application to the details of the particular arrangements shown, since other embodiments are possible. Also, the terminology used herein is for the purpose of description and not of limitation.

### DETAILED DESCRIPTION

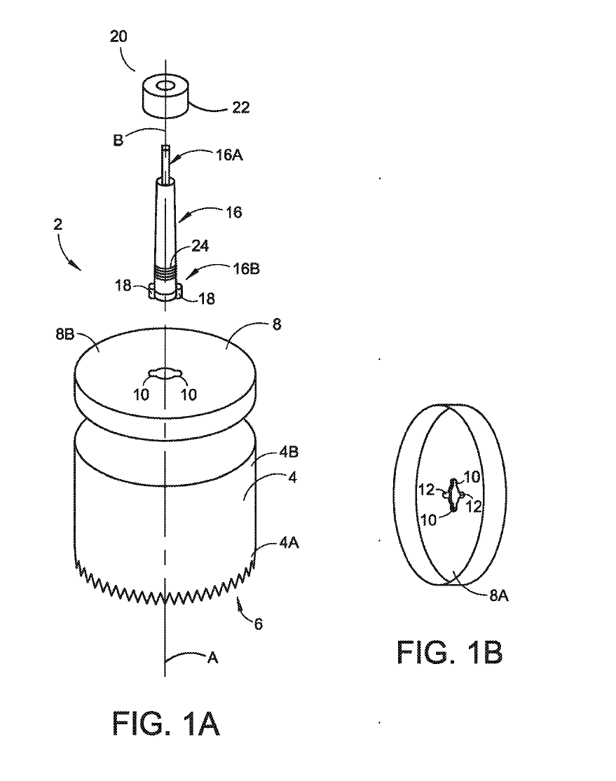

FIGS. 1A-1B illustrate a hole-saw 2 according to one or more embodiments. The hole-saw 2 includes a cylindrical body 4, a plate 8, and a mandrel 16.

The body 4 has a first cutting edge 6 formed at a first end 4A of the body 4 that is open. This first cutting edge 6 is disposed about a rotational axis A of the body.

The plate 8 is disposed at a second end 4B of the body 4 different than the first end 4A. Although illustrated as separate from the body 4 in FIGS. 1A-1B for explanatory purposes, the plate 8 is rotationally coupled to the body 4 such that rotation of the plate 8 or the body 4 results in rotation of the other. The plate 4 is oriented perpendicular to the body's rotational axis A, as shown.

Notably, the plate 8 has lateral slots 10 formed through the plate 8. As shown in FIGS. 1A-1B, for example, the plate 8 has a single pair of lateral slots 10 that extend laterally, e.g., in opposite directions, from a circular hole through the plate's center. The plate 8 in alternative embodiments, though, has any number of lateral slots 10 more than one.

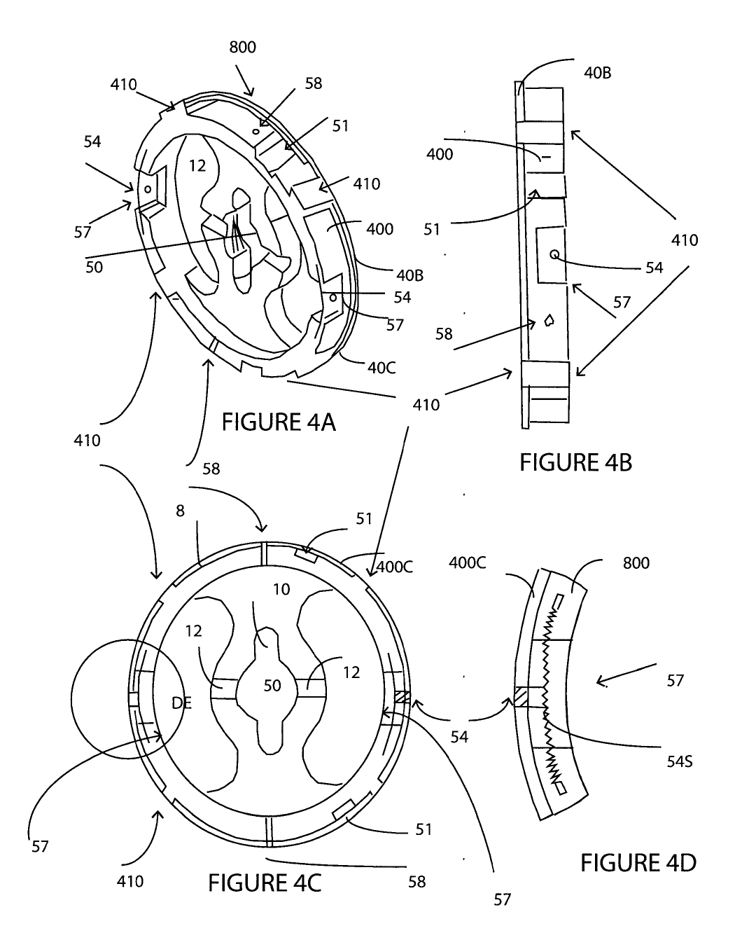

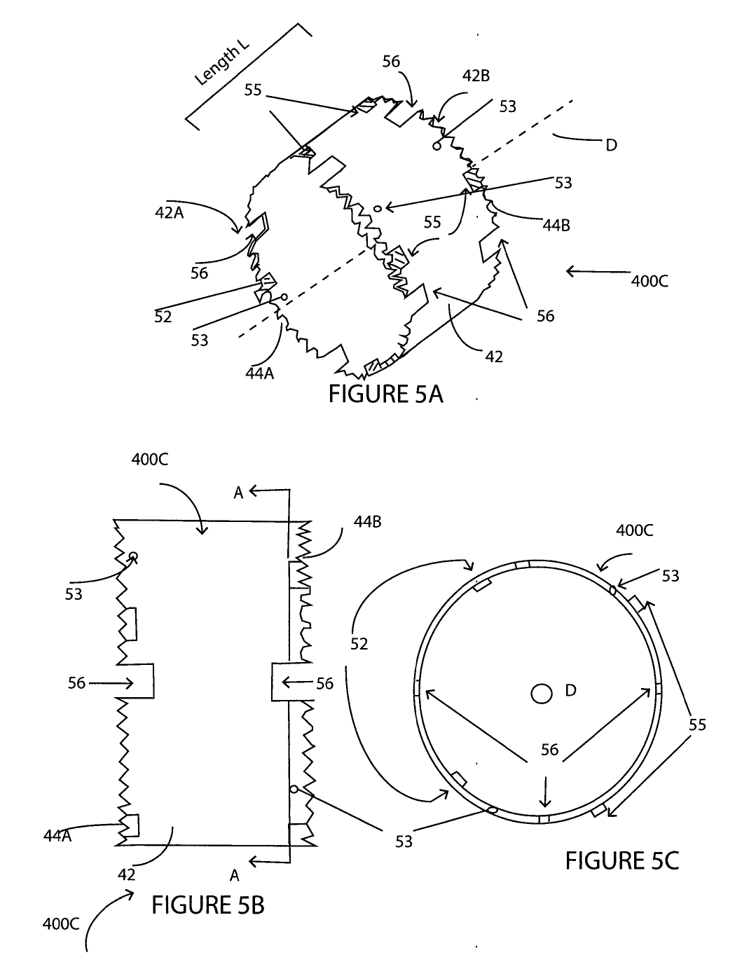

One or more other embodiments herein thereby include a double-edge hole-saw cup. The cup comprises a cylindrical body 400C as shown in FIGS. 5A-5B. As shown, the body 400C has a first cutting edge 44A formed at a first open end 42A of the body 400C and a second cutting edge 44B formed at a second open end 42B of the body 400C. The first and second cutting edges 44A, 44B are disposed about a rotational axis D of the body 400C. Notably, the cylindrical body 400C is hollow through its entire length L. The cup further includes a plate configured to interchangeably couple to the first and second ends 42A, 42B of the body 400C in an orientation perpendicular to the body's rotational axis D. As shown, the body also has first slots 56 disposed around the first open end 42A of the body 400C. The body 400C also has second slots 56 disposed around the second open end 42B of the body 400C. Tabs 410 of FIG. 4A are configured to engage respective ones of the slots 56 when the plate 800 is coupled to the first end 42A or the second end 42B, respectively.

The plate 800 also may have lateral grooves 12 formed in a distal surface 8A (i.e., underside) of the plate 8. The top of plate 8 is labeled 8B. The grooves 12 or channels are formed in this surface 8A, rather than extending through the plate 8 like the slots 10. For example, the plate 8 in one or more embodiments has a defined thickness, and the slots 10 extend all the way through that thickness whereas the grooves 12 extend only partially through the plate's thickness. Regardless, the grooves 12 are formed in an orientation transverse to the slots 10. In the embodiment shown in FIGS. 1A-1B, there are two slots 10 and two grooves 12, and the grooves 12 are formed in an orientation perpendicular to the slots 10. Alternate embodiments would be a threaded hole in the center of plate 8, a prior art design.

The hole-saw 2 also includes a mandrel 16. The mandrel 16 has a proximal section 16A and a distal section 165. The proximal section 16A forms an arbor shaft, e.g., for attaching to a drill chuck. The distal section 16B includes lateral bosses 18 that are sized to insert through the plate's slots 10 and rest in the plate's grooves 12.

With the bosses 18 aligned with the plate's slots 10, the mandrel's distal section 16B and bosses 18 insert through the slots 10. The mandrel 16 is then rotated or twisted about its longitudinal axis B until the bosses 18 align with the plate's inner grooves 12 formed in the plate's distal surface 8A. The mandrel 16 is then moved backward relative to the body along the body's rotational axis A such that the bosses 18 engage and rest in the plate's grooves 12.

In practice, for example, the mandrel 16 is moved in. the direction of the body's rotational axis A towards the plate 8. With the bosses 18 aligned with the plate's

slots 10, the mandrel's distal section 16B and bosses 18 insert through the slots 10. The mandrel 16 is then rotated or twisted about its longitudinal axis 8 until the bosses 18 align with the plate's inner grooves 12 formed in the plate's distal surface 8A. The mandrel 16 is then moved backward relative to the body along the body's rotational axis A such that the bosses 18 engage and rest in the plate's grooves 12.

In any event, the hole-saw further includes a clamping member 20 for clamping the plate 8 between the clamping member 20 and the bosses 18 resting in the plate's grooves 12. The clamping member 20 in this regard has a body 22 that is movable along the mandrel's longitudinal axis B to engage a proximal surface 8B of the plate 8. In one embodiment, for example, the clamping member 20 comprises at least one hut configured to screw along outer threads 24 of a center section of the mandrel to engage the plate's proximal surface 8B. With the bosses 18 resting in the plate's grooves, the clamping member's engagement with the plate's proximal surface 8B clamps the plate 8 between the clamping member 20 and the bosses 18, so as to rotationally couple the body 4, plate 8, and mandrel 16 (e.g., in an end-to-end manner).

In at least some embodiments, rotationally coupling the body 4, plate 8, and mandrel 16 in this way proves advantageous in that it eliminates or at least reduces wobbling between the body 4, plate 8, and/or mandrel 16 (as compared to existing hole-saws).

In some embodiments, such as those in FIGS. 1A-1B, the plate 8 has a single pair of slots 10 extending laterally in opposite directions from a circular hole through the center of the plate 8. And the plate 8 has a single pair of grooves 12 extending laterally in opposite directions from the plate's circular hole and in an orientation transverse to the slots 10. And, finally, the mandrel's distal section 16B includes a single pair of bosses 18. In other embodiments, there may be more than two (e.g.,. 3 or 4) slots 10, grooves 12, and bosses 18. In at least one or more embodiments, though, there are an equal number of slots 10, grooves 12, and bosses 18.

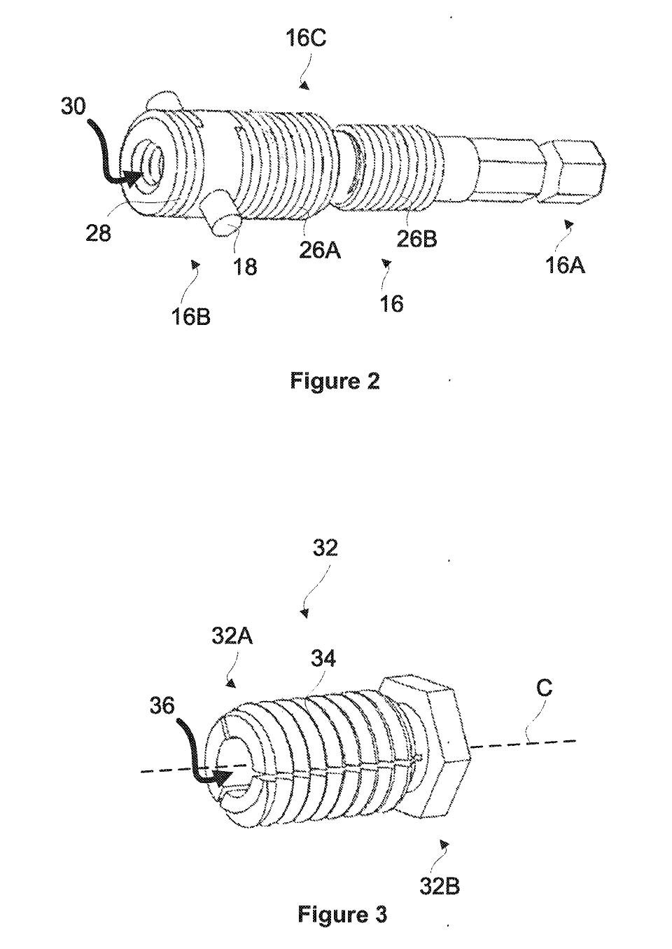

FIG. 2 illustrates the mandrel 16 according to one or more embodiments. As shown in FIG. 2, the mandrel has a center section 16C between the mandrels' proximal and distal sections 16A, 16B. This center section 16C has two different threaded portions 26A and 26B that include outer threads with different handedness (e.g., a standard thread with right-handedness and a reverse thread with left-handedness). Handedness in this regard refers to the direction that a thread's helix twists or rotates. In this case, the clamping, member 20 includes different nuts configured to screw along respective ones of the threaded portions 26A, 26B to engage the plate's proximal surface 88. Using multiple nuts in this way (e.g., as a double nut locking system) advantageously guards against loosening of the coupling between the plate 8, the mandrel 16, and the body 4. Although the threaded portions 26A and 26B are shown in FIG. 2 as being separated by a non-threaded portion, such need not be the case. Alternatively or additionally, the mandrel 16 is configured to interchangeably and rotationally couple to a different plate (not shown). Specifically, the mandrel 16's distal section in this case also includes outer threads 28 disposed opposite the bosses 18 from the mandrel's proximal section 16A, as shown in FIG. 2. These outer threads 28 are configured to screw into inner threads of the different plate. The outer threads 28 thereby serve as an alternative to the bosses 18/clamping member 20, so that the mandrel 16 is capable of coupling to multiple different plates (e.g., including conventional plates at different times). Also alternatively or additionally, the mandrel 16 in some embodiments has a threaded hole 30 at an end of the mandrel's distal section 16B. This threaded hole 30 is sized and configured to receive a threaded (e.g., locking) collet that holds a pilot bit.

FIG. 3 illustrates one example of such a threaded collet 32. As shown, the collet 32 has outer threads 34 formed at the collet's proximal end 32A. These outer threads 34 screw into inner threads of the threaded hole 30. The collet 32 also has a hole 36 formed through its center along the collet's longitudinal axis C for receiving a pilot bit (not shown). The pilot bit's non-drilling end may be, for example, inserted through the hole 36 at the collet's distal end 32B and along the collet's longitudinal axis so as to be clamped in place by a tapered outer collar.

Securing a pilot bit to the mandrel 16 using a collet in this way advantageously makes the pilot bit easier to replace and/or makes the hole-saw able to use standard drill bits. Indeed, unlike conventional hole-saws that require removal of the mandrel from the hole-saw cup in order to replace the pilot bit, or require a proprietary or non-replaceable bit, the mandrel 16 and collet herein allow the pilot bit to be replaced without having to uncouple the mandrel 16 from the plate 8 or body 4.

Although the plate 8 is shown in FIGS. 1A-1B as just having lateral slots 10, the plate 8 in some embodiments includes one or more additional slots formed through the plate 8 that at least partially circumscribe the lateral slots 10 (e.g., by at least halfway). The additional slot(s) may for instance reduce raw materials (e.g., by about 70%) and/or provide one or more escape outlets for saw dust.

In one or more embodiments, the hole-saw body 4 is a single piece of metal with teeth on both edges, giving two cutting edges on the same saw. According to some embodiments, these are replaceable but at a fraction of the cost, saving money and raw materials.

The shaft in some embodiments has both forward and reverse threads that secure the hole-saw to the mandrel and prevents it from loosening unintentionally.

The bosses 18 in one or more embodiments project outwardly from the shaft and lock into the top plate preventing it from falling off the mandrel.

The lower threaded portion in at least some embodiments is for attaching smaller hole-saws. This allows use of the same mandrel for any size hole-saw from ½″ to 6″.

The threaded hole in some embodiments is a receiving hole into which the looking collet is screwed in, which secures the pilot bit in place.

Finally, the locking collet in one or more embodiments allows for easy changing of standard pilot bits, which are cheaper and easier to find.

Those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

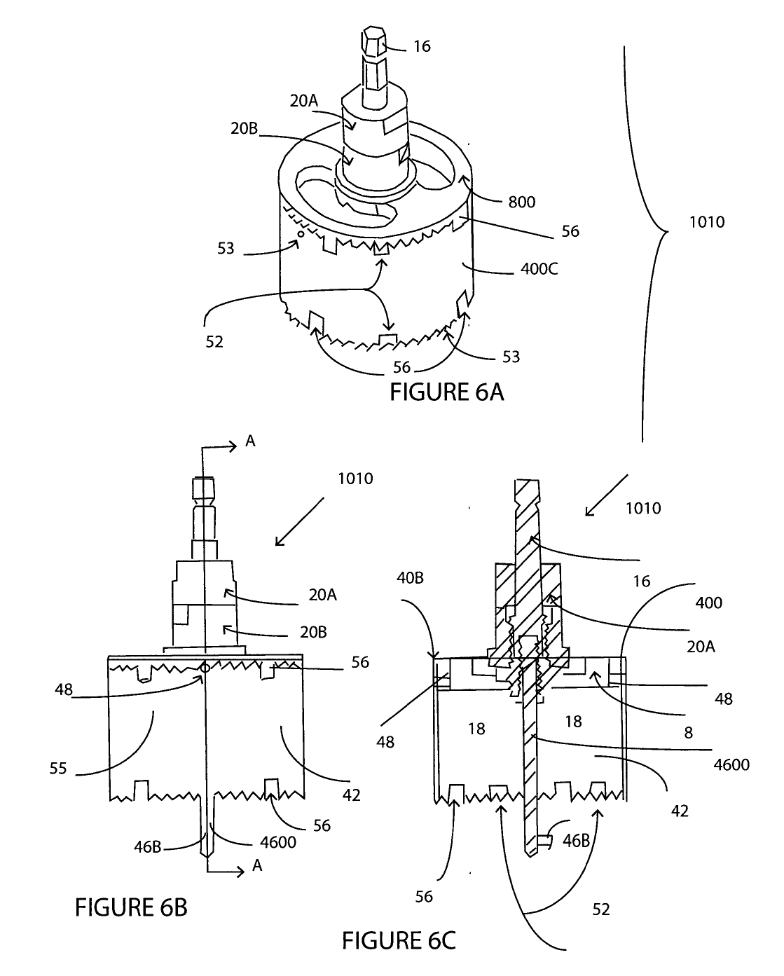

Referring to FIG. 4A a hole saw plate 800 has a peripheral wall 400. Tabs 410 extend laterally from the peripheral wall 400. A lip 40B extends laterally from the proximal (top) surface of the plate 800. Threaded holes 58 receive a set screw, see FIG. 6C. Notches 51 are sized to receive inner saw teeth 52 shown, in FIGS. 5A-5C. Recesses 57 in the peripheral wall 400 house an alternate mounting means shown in FIG. 4C, 4D. A spring 54S braces a pin 54 that engages a hole 53 in the hole saw body 400C. A pointed tool such as a punch can be used to push the pins 54 inward to install or remove the hole saw body 400C from the plate 800. This design could be used in place of set screws 48 or in addition to set screws 48 as a design choice. The combination of the lip 40B and the outer wall 400 is referred to as a rabbeted edge, wherein other design choices are known in the art. Referring next to FIGS. 5A-5C a hole saw blade 400 C has identical distal and proximal ends, 42A and 42B, with saw teeth 44A, 44B a plurality of holes 53 are placed near the ends 42A, 42B. Holes 53 can receive a set screw 48 or a pin 54 or an equivalent rotational and mounting connection to the plate 800. The notches 56 provide a rotational connection to the tabs 410 on plate 800.

A set of inner saw teeth 52 and/or outer saw teeth 55 cut the workplace so that the plug readily falls out of the hole saw blade 400C. The prior art discloses two separate hole saw blades to accomplish this feature.

Referring next to FIGS. 6A-6C the hole saw assembly 1010 has a mandrel 16 clamping members 20A, 20B, and plate 800. Not shown are variations for the hole saw blade 400C. These variations can include one end not having inner teeth, or one end not having any saw teeth at all. That design would merely present inner teeth 52 on a one blade hole saw as seen in FIG. 6C.

The pilot bit 4600 has a burr 46B that enlarges the pilot hole so as to prevent the bit from getting jammed in the pilot hole. Many designs are equivalent to burr 46B such as two or more hurts or a mini cylindrical collar. As long as a lateral extension means from the distal end of the bit 4600 cuts a larger hole than bit 4600, it can be used.

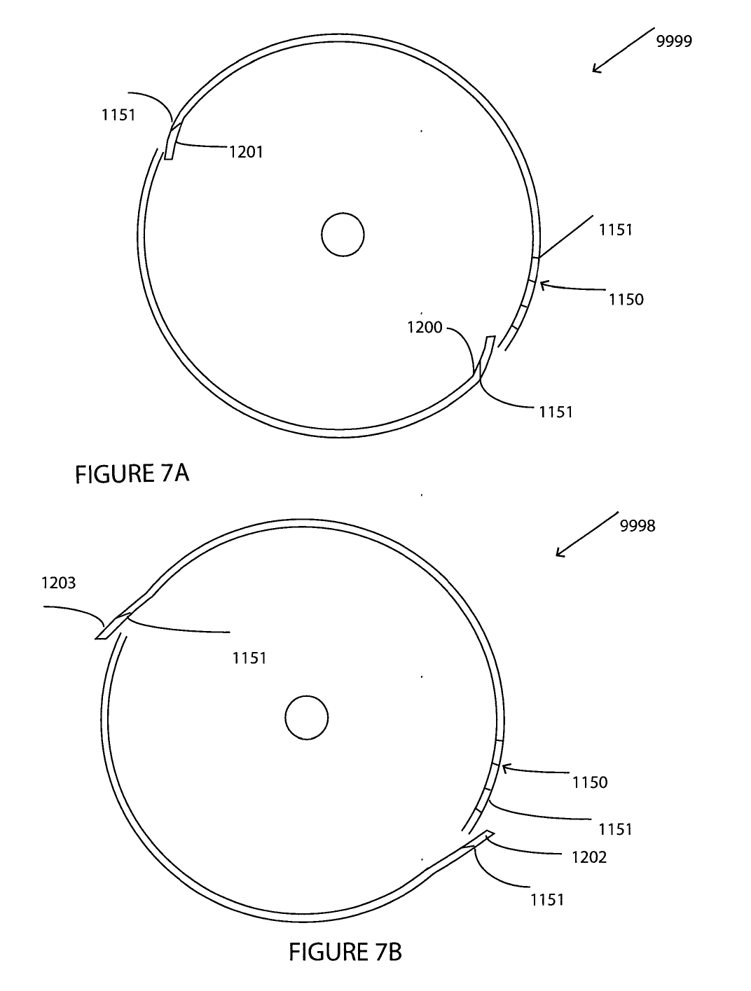

Referring next to FIG. 7A a carting end 1150 of a hole saw 9999 has teeth 1151. Inner teeth 1200, 1201 are formed by cutting a notch in the cutting end and bending inward a blade segment 1200, 1201. The height of the notch up the sidewall of the hole saw is a matter of design choice. A prototype performed well with a notch height of one quarter inch.

Referring next to FIG. 7B a cutting end 1150 of a hole saw 9998 has teeth 1151. Outer teeth 1202, 1203 are formed by cutting a notch in the cutting end and bending outward a blade segment 1202, 1203.

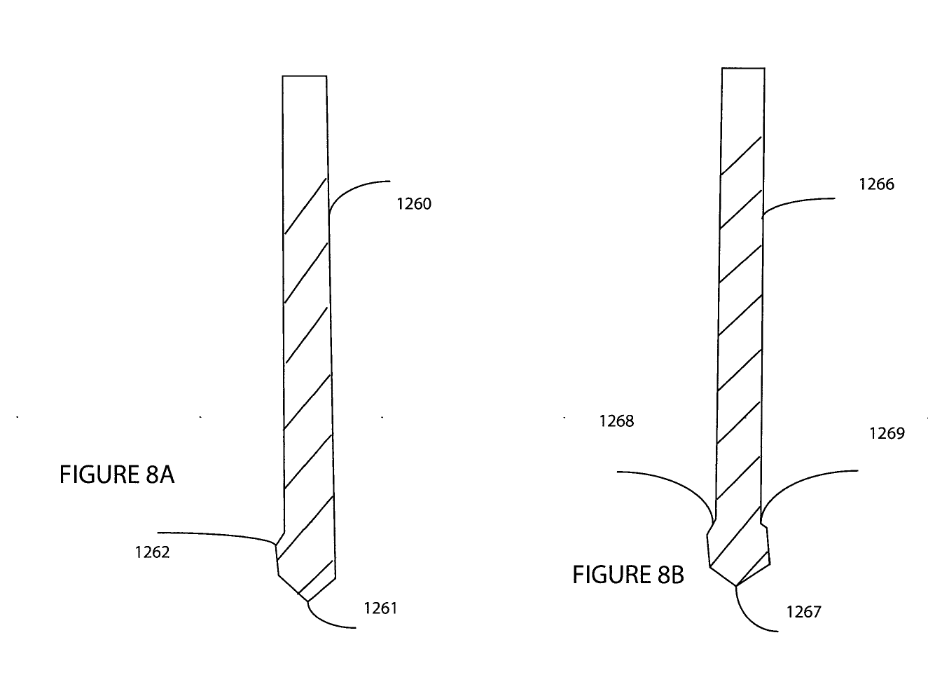

Referring next to FIG. 8A a pilot bit 1260 has a tip 1261. A burr 1262 adjacent the tip 1261 enlarges the drilled hole to mitigate any jamming of the pilot bit 1260.

Referring next to FIG. 8B a pilot bit 1266 has a tip 1267, Burrs 1268 and 1269 enlarge the drilled hole to mitigate any jamming of the pilot bit 1266. While a number of exemplifying features and embodiments have been discussed above, those of skill in the art will recognize certain modifications, permutations, additions and subcombinations thereof. No limitation with respect to the specific embodiments disclosed herein is intended or should be inferred.

I claim:

1. A mandrel assembly for a hole saw, said
mandrel assembly comprising;
a mandrel having a body and a first, and second end, said first end for coupling with a drill motor, said second end extending from said body and including a mechanism for receiving a hole saw;
said mechanism including a plate removably affixed to the second end by a threaded clamping member that rotationally couples the mandrel to the plate;
said hole saw blade having a distal open end with saw teeth;
said hole saw blade having at least one inner saw tooth to reduce a diameter of a plug; and
a pilot drill bit attached to the second end and having a burr.
